(19) United States
(12) Patent Application Publication
(10) Pub. No.: US 2014/0094247 A1
(43) Pub. Date: Apr. 3, 2014

(54) GAMING METHOD AND GAMING MACHINE

(71) Applicants: UNIVERSAL ENTERTAINMENT CORPORATION, Tokyo (JP); ARUZE GAMING AMERICA, INC., Las Vegas, NV (US)

(72) Inventors: Hiromoto YAMAUCHI, Tokyo (JP); Kazuo OKADA, Tokyo (JP)

(73) Assignees: Aruze Gaming America, Inc., Las Vegas, NV (US); Universal Entertainment Corporation, Tokyo (JP)

(21) Appl. No.: 13/629,644

(22) Filed: Sep. 28, 2012

(51) Int. Cl. A63F 13/00

(52) U.S. Cl. 463/20

(57) ABSTRACT

A map symbol to be substituted with another symbol is included in a symbol set for a game. When two or more map symbols are included in a symbol arrangement, symbols in a subset of the symbol set are scrolled on display blocks occupied by the map blocks in a simultaneous manner. Each of the map symbols is substituted with another symbol in the subset, thereby forming a finalized symbol arrangement. A payout process is performed based on the finalized symbol arrangement.

### BACKGROUND

(a) Field

The present invention generally relates to a gaming method and a gaming machine.

(b) Description of the Related Art

A conventional gaming machine includes a display arranged with a plurality of symbols. The gaming machine rearranges the symbols in a unit game, and awards a payout to a player according to the combination of rearranged symbols (for example, U.S. Patent Application Publication No. 2008/0058067 and U.S. Patent Application Publication No. 2008/0058072). The player can start another unit game after one unit game ends.

However, in the conventional gaming machine, although the unit games are repeatedly executed, there is continuity of the unit games. Since the conventional gaming machine does not provide the continuity of the unit games, it is difficult to attract a player's interest in a game.

### SUMMARY

A gaming machine according to an embodiment of the present invention includes: a display device that includes a plurality of display blocks arranged in rows and columns; a memory that stores a first reel data including a plurality of first symbols and a first plurality of win-related symbols and a second reel data including a second plurality of win-related symbols, the first reel data configured to be scrolled entirely in the columns of the display blocks and the second reel data configured to be scrolled locally in one or more of the display blocks; a controller configured to award a prize for a symbol arrangement including the win-related symbols, wherein from begging of a game round to completion of arranging the win-related symbols, the controller configured to scroll first reel images including the plurality of first symbols and the first plurality of win-related symbols in each of the columns of the display device based on the first reel data, to stop the first reel images at random entirely in each of the columns of the display device, to scroll second reel images including the second plurality of win-related symbols locally in a first display block of the display blocks based on the second reel data when it is determined that a first one of the plurality of first symbols stops in the first display block, to stop the second reel images at random in the first display block, and to award a prize based on a finalized symbol arrangement obtained after stopping the second reel images.

The memory further stores a prize table that determines prizes for wins formed by at least one of the win-related symbols.

The controller is configured to scroll the second reel images locally in a second display block of the display blocks based on the second reel data when it is determined that a second one of the plurality of first symbols stops in the second display block, and the scroll in the first display block and the scroll in the second display block start simultaneously and stop simultaneously.

An arrangement of the second plurality of the win-related symbols in the second reel data for the scroll in the second display block is different from an arrangement of the second plurality of the win-related symbols in the second reel data for the scroll in the first display block.

An arrangement of the second plurality of the win-related symbols in the second reel data for the scroll in the second display block is substantially the same as an arrangement of the second plurality of the win-related symbols in the second reel data for the scroll in the first display block, and any two of the second plurality of the win-related symbols in the second reel data are different from each other.

The second plurality of the win-related symbols in the second reel data include a wild symbol that is configured to substitute for any other symbol.

A proportion of the number of the wild symbol in the second reel data is greater than a proportion of the number of the wild symbol in the first reel data.

The controller may be further configured to determine whether the finalized symbol arrangement includes a win, to determine a multiplier when the finalized symbol arrangement includes a win, and to calculate a final prize based the win and the determined multiplier.

The controller may be further configured to display a character on the display device, the character rotating for a predetermined time to show a plurality of candidate multipliers and stopping to show the determined multiplier.

A gaming method according to an embodiment of the present invention includes: scrolling a set of symbols on a display device, the set of symbols including first symbols and other symbols; stopping a symbol arrangement including symbols selected from the set of symbols on the display device, each symbol in the symbol arrangement occupying a display block of the display device; determining whether the symbol arrangement includes at least two of the first symbols; scrolling a first subset of symbols selected from the set of symbols on a first display block occupied by a first one of the at least two of the first symbols when the symbol arrangement includes the at least two of the first symbols; scrolling a second subset of symbols selected from the set of symbols on a second display block occupied by a second one of the at least two of the first symbols when the symbol arrangement includes the at least two of the first symbols; stopping a second symbol and a third symbol in the first display block and the second display block, respectively, the second symbol selected from the first subset of symbols and the third symbol selected from the second subset of symbols, thereby forming a finalized symbol arrangement; and determining payout based on the finalized symbol arrangement, wherein the scrolling the first subset of symbols on the first display block and the scrolling the second subset of symbols on the second display block are performed in a simultaneous manner.

The scrolling of the first subset of symbols on the first display block and the scrolling of the second subset of symbols on the second display block may start simultaneously and may stop simultaneously.

The first subset of symbols may be substantially the same as the second subset of symbols.

Each of the first and second subsets of symbols may include a wild symbol that is configured to substitute for other symbols.

A proportion of the number of the wild symbol in each of the first and second subsets of symbols may be greater than a proportion of the number of the wild symbol in the set of symbols.

The determining payout may include: determining whether the finalized symbol arrangement includes a win; determining a multiplier when the finalized symbol arrangement includes a win; and calculating a final prize based the win and the determined multiplier.

The determining payout may further include: displaying a character on the display device, the character rotating for a predetermined time to show a plurality of candidate multipliers and stopping to show the determined multiplier.

A gaming method according to another embodiment of the present invention includes: scrolling a set of symbols on a display device, the set of symbols including first symbols and other symbols; determining a symbol arrangement including symbols selected from the set of symbols; stopping the symbol arrangement on the display device, each symbol in the symbol arrangement occupying a display block of the display device; determining whether the symbol arrangement includes at least two of the first symbols; scrolling a first subset of symbols selected from the set of symbols on a first display block occupied by a first one of the at least two of the first symbols when the symbol arrangement includes the at least two of the first symbols; scrolling a second subset of symbols selected from the set of symbols on a second display block occupied by a second one of the at least two of the first symbols when the symbol arrangement includes the at least two of the first symbols; determining a second symbol from the first subset of symbols to substitute for the first one of the at least two of the first symbols; determining a third symbol from the second subset of symbols to substitute for the second one of the at least two of the first symbols; stopping the second symbol and the third symbol in the first display block and the second display block, respectively, thereby forming a finalized symbol arrangement; and determining payout based on the finalized symbol arrangement, wherein the scrolling the first subset of symbols on the first display block and the scrolling the second subset of symbols on the second display block are performed in a simultaneous manner.

The scrolling of the first subset of symbols on the first display block and the scrolling of the second subset of symbols on the second display block may start simultaneously and may stop simultaneously.

The first subset of symbols may be substantially the same as the second subset of symbols.

The second symbol may be the same as the third symbol.

### BRIEF DESCRIPTION OF THE DRAWINGS

FIG. 1 is a schematic block diagram of a gaming machine according to an embodiment of the present invention.

FIG. 2 is a schematic view of symbol strips in a gaming machine according to an embodiment of the present invention.

FIG. 3 illustrates symbols used in a game according an embodiment of the present invention.

FIG. 4 is a schematic flow chart illustrating a gaming method according to an embodiment of the present invention.

FIGS. 5A and 5B are screen shots illustrating a gaming method according to an embodiment of the present invention.

FIGS. 6A and 6B show an exemplary symbol code table for a symbol arrangement according to an embodiment of the present invention.

FIG. 7 is an exemplary symbol code table for substituting for a map symbol according to an embodiment of the present invention.

FIG. 8 is a schematic block diagram of an exemplary gaming machine showing a functional flow of the gaming machine according to an embodiment of the present invention.

FIG. 9 is a schematic block diagram of an exemplary external controller showing a functional flow of the gaming machine shown in FIG. 8 according to an embodiment of the present invention.

FIG. 10 is a schematic perspective view of the gaming machine shown in FIG. 8.

FIG. 11 is a schematic block diagram of an exemplary gaming system according to an embodiment of the present invention.

FIG. 12 is a schematic block diagram of an exemplary PTS system for a gaming machine according to an embodiment of the present invention.

FIG. 13 is a schematic perspective view of an exemplary slot machine in a gaming machine according to an embodiment of the present invention.

FIG. 15 is a schematic flow chart illustrating a gaming method according to an embodiment of the present invention.

FIG. 16 shows screen shots illustrating a gaming method according to an embodiment of the present invention.

FIG. 17 is a schematic flow chart showing a free mode process of a game according to an embodiment of the present invention.

FIG. 18 are exemplary screen images illustrating a gaming method according to an embodiment of the present invention.

FIG. 19 shows rotation of a moai character in a gaming method according to an embodiment of the present invention.

### DETAILED DESCRIPTION

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Outline of Gaming Machine and Gaming Method

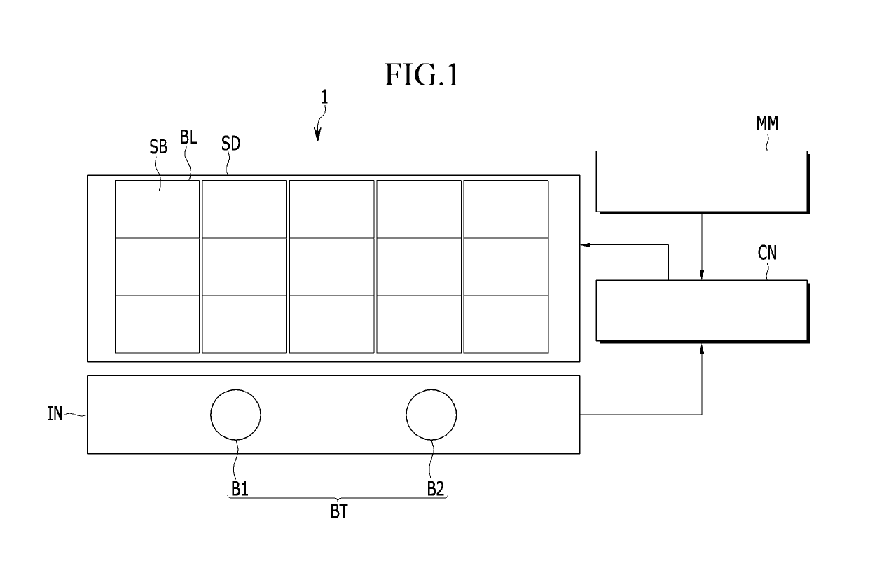

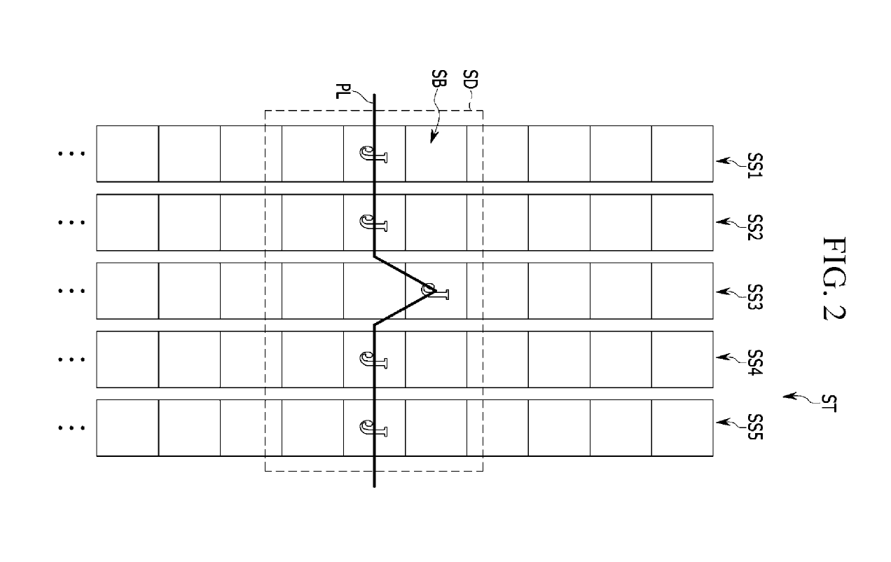

A gaming machine according to an embodiment of the present invention is described with reference to FIG. 1 to FIG. 3.

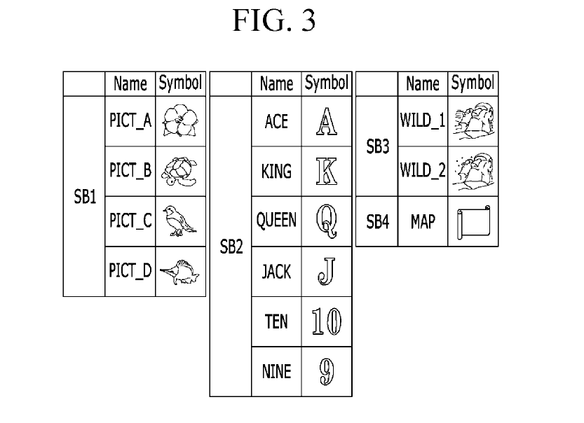

FIG. 1 is a schematic block diagram of a gaming machine according to an embodiment of the present invention, FIG. 2 is a schematic view of symbol strips in a gaming machine according to an embodiment of the present invention, and FIG. 3 illustrates symbols used in a game according an embodiment of the present invention.

Referring to FIG. 1, a gaming machine 1 according to an embodiment of the present invention includes a symbol display SD, an input unit IN, a memory MM, and a controller CN connected to the symbol display SD and the input unit IN. The gaming machine 1 may execute a game in a normal mode or a free mode.

The symbol display SD displays a set of symbols SB for the game, in a moving state or in a stop state. Referring to FIG. 2, the symbols SB in a symbol set ST may be disposed on a plurality of reels that may be virtual/video reels or actual/mechanical reels, and each reel carries a series of the symbols SB forming a symbol strip SS1-SS5. Each symbol strip SS1-SS5 starts to move, spin, or scroll to perform a rendering movement, and then stops the movement in an execution (or a round) of the game. A predetermined number of consecutive symbols in each symbol strip SS1-SS5 can be displayed on the symbol display SD in the stop state while remaining symbols are not shown on the symbol display SD. The symbols SB shown on the symbol display SD in the stop state occupy respective display blocks BL of the symbol display SD arranged in rows and columns and form “a symbol arrangement.” According to an embodiment of the present invention, a set of symbols SB includes five symbol strips SS1-SS5, and three symbols selected from each of the five symbol strips SS1-SS5, that is, a total of fifteen symbols form a symbol arrangement in a shape of a 3×5 matrix.

FIG. 2 shows an exemplary payline PL that passes through a row in each column of a symbol arrangement. When a group of the symbols SB in the symbol arrangement placed on the payline PL satisfies a predetermined condition, a player may win the game. For example, when two, three, or more symbols SB successively arranged from a first symbol strip SS1 to right along the payline PL are the same, the gaming machine 1 may award a prize to the player. Such a combination of the symbols SB that provides a win is referred to as a “winning combination.” Various paylines may be drawn, and two or more of the paylines may be selected by the player to expect more probability of win.

In addition to a win with the payline PL (referred to as a “line win”), there is another type of win referred to as a “scatter win” that is given when one or more of predetermined symbols are shown on the symbol display SD although they are scattered.

The symbols SB may include ordinary symbols and special symbols including wild symbols and a function symbol, for example. The wild symbol can substitute for any other symbol except for the function symbol to create a winning combination. According to an embodiment of the present invention, a predetermined number of the wild symbols may trigger a free mode of the game. The function symbol may be substituted with another symbol determined at random. According to an embodiment of the present invention, the map symbol may be substituted with a symbol selected from a subset of the symbol set, and the subset may include the wild symbol at a higher occurrence proportion than the symbol set. For example, a proportion of the number of the wild symbols in the subset may be greater than a proportion of the number of the wild symbols in the symbol set.

FIG. 3 shows various exemplary symbols including picture symbols SB1, character symbols SB2, wild symbols SB3, and a function symbol SB4. The picture symbols SB1 may include four picture symbols PICT_A, PICT_B, PICT_C, and PICT_D that are denoted by pictures of a flower, a turtle, a bird, and a fish, respectively. The character symbols SB2 may include six character symbols ACE, KING, QUEEN, JACK, TEN and NINE that are denoted by “9,” “10,” “J,” “Q,” “K,” and “A,” respectively. The wild symbols SB3 may include a first wild symbol WILD_1 denoted by a picture of a moai in daytime and a second wild symbol WILD_2 denoted by a picture of a moai in nighttime. The function symbol SB4 may include a map symbol MAP denoted by a picture of a map.

The ordinary symbols SB1 and SB2 and the wild symbols SB3 may form a win while the function symbol SB4 or the map symbol SB4 may not form a win. Hereinafter, the ordinary symbols and the wild symbols will be referred to as “win-related symbols.”

Referring to FIG. 1 again, the memory MM stores a first reel data including a plurality of the map symbols MAP and a first plurality of win-related symbols and a second reel data including only a second plurality of win-related symbols. The plurality of the map symbols MAP and the first plurality of win-related symbols may be scrolled in each columns of the display device in a column direction based on the first reel data. The second plurality of win-related symbols may be scrolled in one or more of the display blocks BL based on the second reel data.

The memory MM may further store a prize table for determining a prize for each win, and the win may be formed by at least one of the win-related symbols.

The input unit IN includes a plurality of buttons BT, for example, a bet button B1 and a spin button S1 that are operable by a player. The bet button B1 is used for betting on a game, and the spin button B2 is used for spinning the reels RL to get a new arrangement of the symbols SB (or for starting the game).

The controller CN receives inputs from the input unit IN and controls the symbol display SD with the symbols SB in response to inputs from the input unit IN.

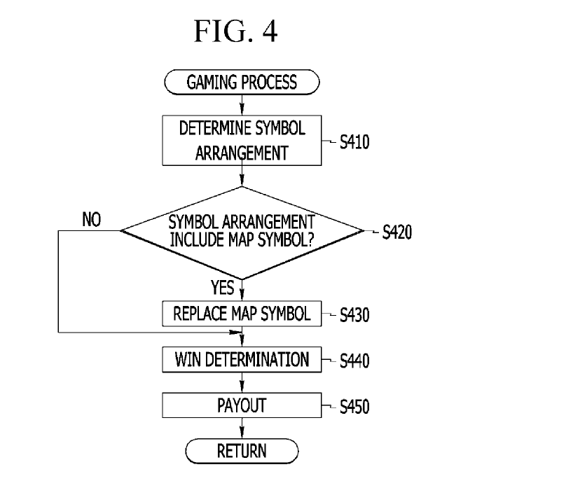

Now, a gaming method according to one or more embodiments of the present invention is described in detail with reference to FIG. 4 to FIG. 7 as well as FIG. 1 to FIG. 2.

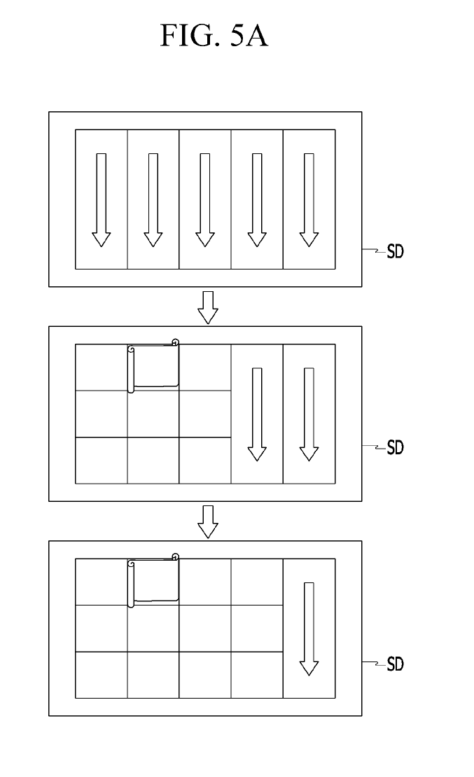

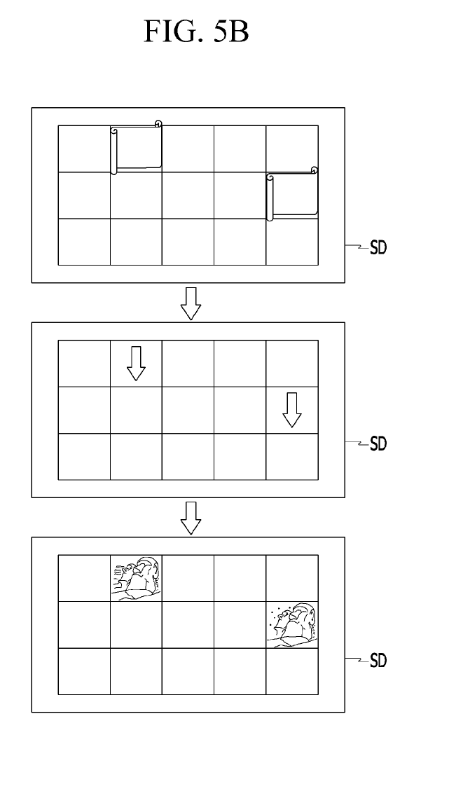

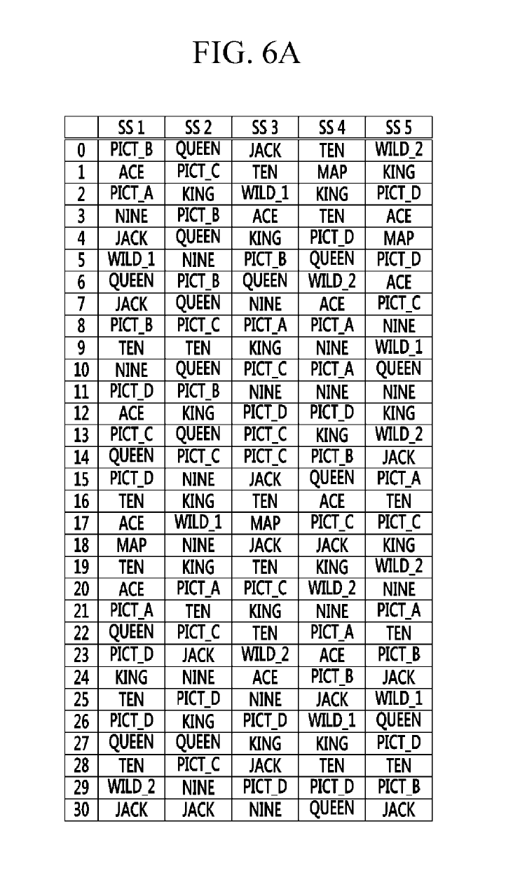

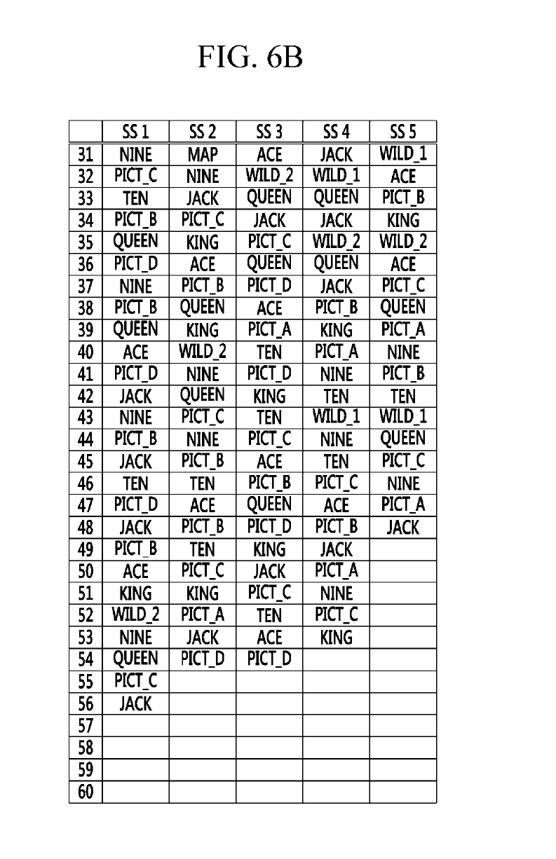

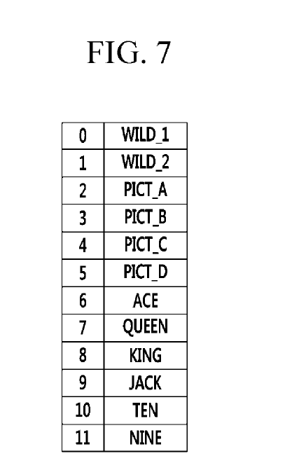

FIG. 4 is a schematic flow chart illustrating a gaming method according to an embodiment of the present invention, FIGS. 5A and 5B are screen shots illustrating a gaming method according to an embodiment of the present invention, FIGS. 6A and 6B show an exemplary symbol code table for a symbol arrangement according to an embodiment of the present invention, and FIG. 7 is an exemplary symbol code table for substituting for a map symbol according to an embodiment of the present invention.

The controller CN of the gaming machine 1 may make the symbol display SD display a plurality of symbols SB before starting a game, and the controller CN executes a round of the game in response to inputs from a player. The inputs from the player may include an input from the bet button B1 and another input from the spin button B2 shown in FIG. 1. The player may determine a bet amount by pressing the bet button B1, and starts the game round by pressing the spin button B2.

Referring to FIG. 4, upon Receipt of the input from the spin button B2, the controller CN may determine a symbol arrangement including a group of symbols selected from a predetermined symbol code table, for example, by using a random number generator (not shown) (S410). An example of the symbol code table is shown in FIGS. 6A and 6B.

Referring to FIGS. 6A and 6B, each of the symbol strips SS1-SS5 may include a map symbol MAP according to an embodiment of the present invention, but the number of the map symbol is not limited thereto.

According to an embodiment of the present invention, each of the symbol strips SS1-SS5 may further include at least one first wild symbol WILD_1 and at least one second wild symbol WILD_2 according to an embodiment of the present invention. For example, the symbol code table shown in FIG. 6A and FIG. 6B shows that each of the first and third symbol strips SS1 and SS3 includes one first wild symbol WILD_1 and two second wild symbols WILD_2, and the second symbol strip SS2 includes one first wild symbol WILD_1 and one second wild symbol WILD_2. The fourth symbol strip SS4 includes three first wild symbols WILD_1 and three second wild symbols WILD_2, and the fifth symbol strip SS5 includes four first wild symbols WILD_1 and four second wild symbols WILD_2. However, the number of the map symbol is not limited thereto.

According to an embodiment of the present invention, each of the symbol strips SS1-SS5 may further include at least two same symbols for each of the ordinary symbols PICT_A, PICT_B, PICT_C, PICT_D, ACE, KING, QUEEN, JACK, TEN and NINE. For example, each symbol strip SS1-SS5 may include at least two flower symbols PICT_A, at least two turtle symbols PICT_B, at least two bird symbols PICT_C, at least two fish symbols PICT_D, at least two “A” symbols ACE, at least two “K” symbols KING, at least two “Q” symbols QUEEN, at least two “J” symbols JACK, at least two “10” symbols TEN, and at least two “9” symbols NINE. According to an embodiment of the present invention, the number of the same symbols for each of the ordinary symbols PICT_A, PICT_B, PICT_C, PICT_D, ACE, KING, QUEEN, JACK, TEN and NINE in each of the symbol strips SS1-SS5 may be equal to or greater than the number of the same symbols for each of the special symbols WILD_1, WILD_2, and MAP. However, the symbol code table shown in FIGS. 6A and 6B are merely an example thereof, and it is not limited thereto.

After determining the symbol arrangement, the controller CN determines whether one or more map symbols MAP are included in the symbol arrangement (S420).

When the temporary symbol arrangement includes one or more map symbols MAP (S420: YES), the controller CN determines a symbol that substitutes for each of the map symbols MAP and replaces the map symbol MAP with the substitute symbol(5430), thereby determining a finalized symbol arrangement.

According to an embodiment of the present invention, the substitute symbol may be selected from a symbol code table, for example, by using a random number generator (not shown). FIG. 7 is an example of the symbol code table that includes symbols to be substituted with the map symbol.

Referring to FIG. 7, the symbol code table includes a single symbol strip that includes only one for each of the symbols WILD_1, WILD2, PICT_A, PICT_B, PICT_C, PICT_D, ACE, KING, QUEEN, JACK, TEN and NINE, except for the map symbol MAP, That is, the single symbol strip includes one first wild symbol WILD_1, one second wild symbol WILD_2, one flower symbol PICT_A, one turtle symbol PICT_B, one bird symbol PICT_C, one fish symbol PICT_D, one “A” symbol ACE, one “K” symbol KING, one “Q” symbol QUEEN, one “J” symbol JACK, one “10” symbol TEN, and one at least two “9” symbols NINE. Therefore, the proportion of the number of the wild symbols WILD_1 and WILD2 in the symbol code table shown in FIG. 7 is greater than the proportion of the number of the wild symbols WILD_1 and WILD2 in the symbol code table shown in FIGS. 6A and 6B. Since the probability of the occurrence of the wild symbols WILD_1 and WILD2 is relatively high, a win possibility may be increased.

Referring to FIGS. 5A and 5B that show exemplary screen shots on the symbol display SD related to the above-described steps S410-420, the map symbols MAP and win-related symbols SB1, SB2 and SB3 are scrolled based on the symbol code table shown in FIGS. 6A and 6B in each of the columns of the symbol display SD. The scroll of the columns may stop in sequence from a first column to a fifth column After the scroll in the fifth column stops, a symbol arrangement including two map symbols MAP is shown in the symbol display SD. One of the map symbols MAP is disposed in a display block at a first row and a second column, and the other of the map symbols MAP is disposed in a display block at a second row and a fifth column However, the symbol arrangement may include only one map symbol.

After displaying the symbol arrangement, the symbols WILD_1, WILD2, PICT_A, PICT_B, PICT_C, PICT_D, ACE, KING, QUEEN, JACK, TEN and NINE in the symbol code table shown in FIG. 7 may be scrolled on the display blocks occupied by the map symbols MAP. According to an embodiment of the present invention, the scrolls on the two display blocks may be performed in a simultaneous manner. In detail, the scrolls on the two display blocks may start simultaneously and stop simultaneously.

After the scrolling stops, each of the map symbols MAP is substituted with a symbol included in the symbol code table shown in FIG. 7. The two map symbols MAP may be substituted with the same symbol or different symbols. FIGS. 5A and 5B shows an exemplary case that the two map symbols MAP are replaced with a first wild symbol WILD_1 and a second wild symbol WILD_2.

Referring to FIG. 4 again, the controller performs win determination based on the finalized symbol arrangement (S440), and performs a payout process for the game round (S450).

Outline of Gaming Machine

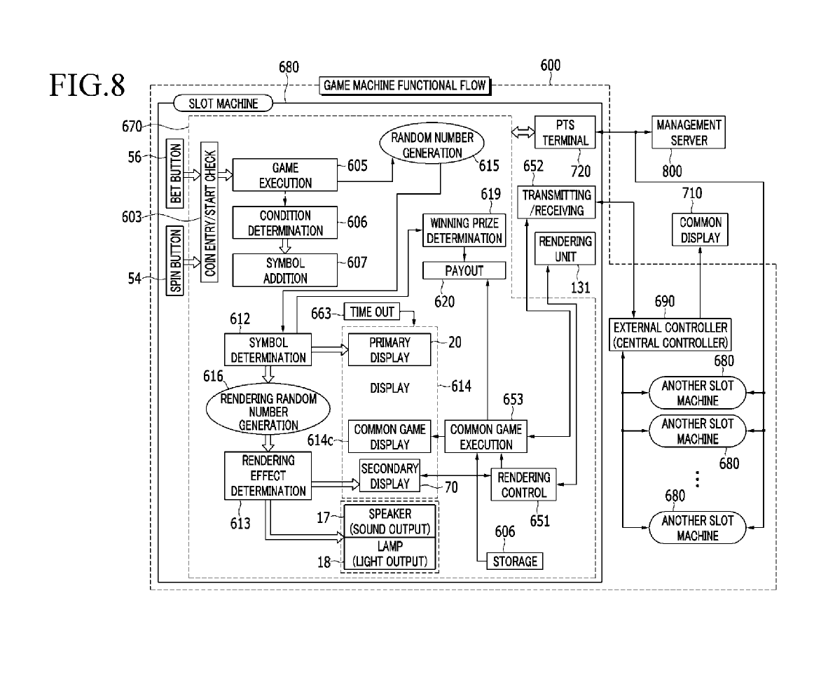

A gaming machine according to another embodiment of the present invention is described with reference to FIG. 8 to FIG. 17.

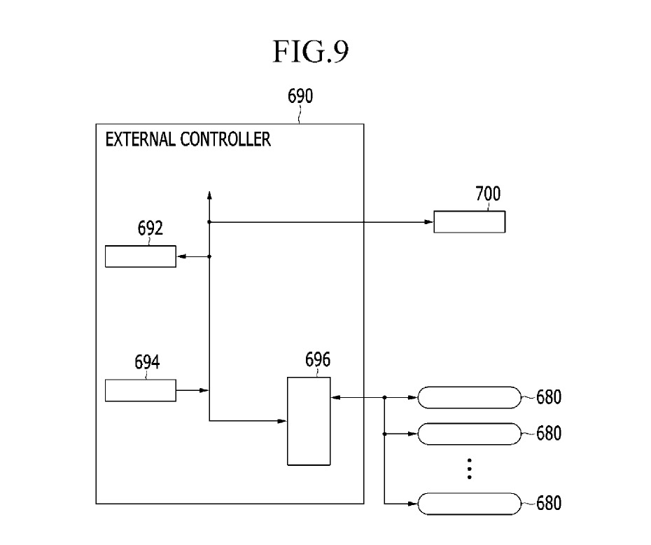

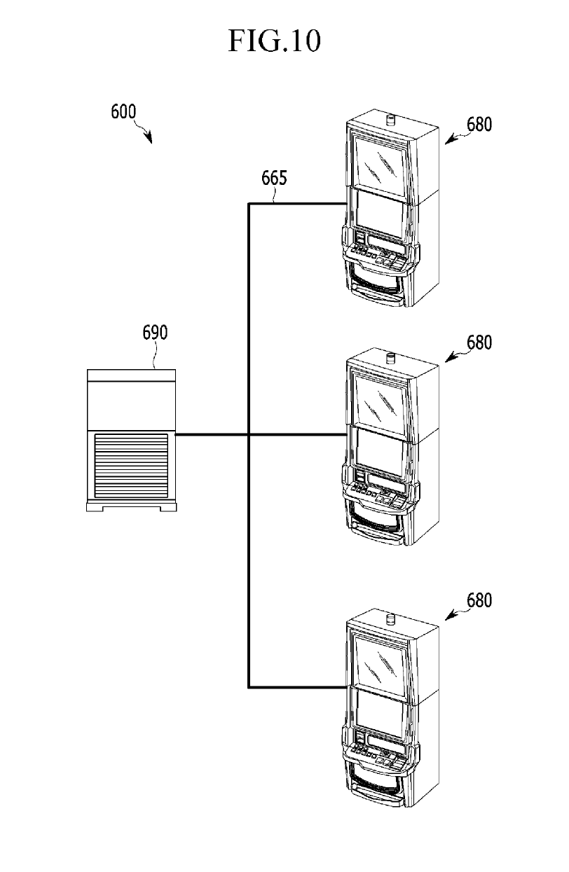

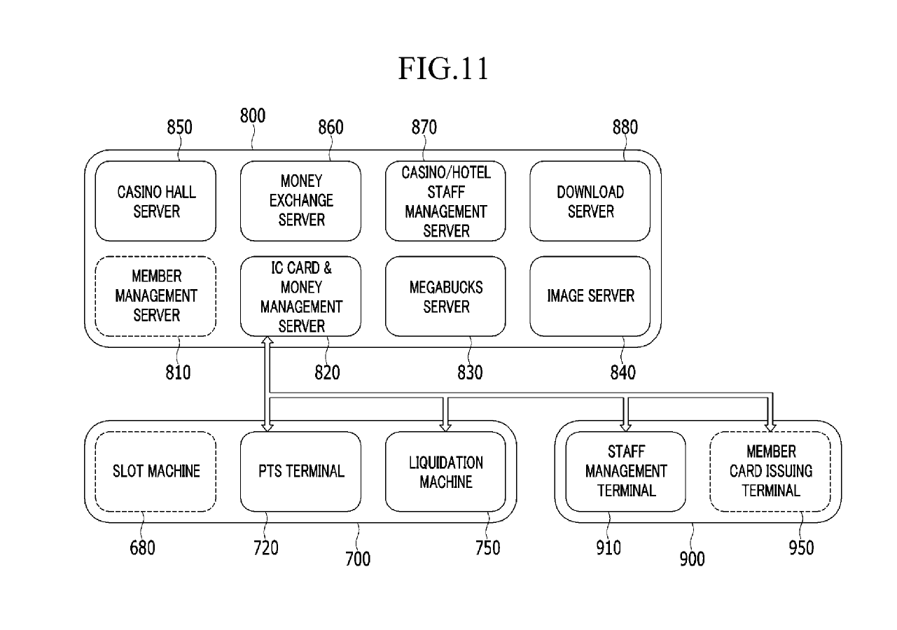

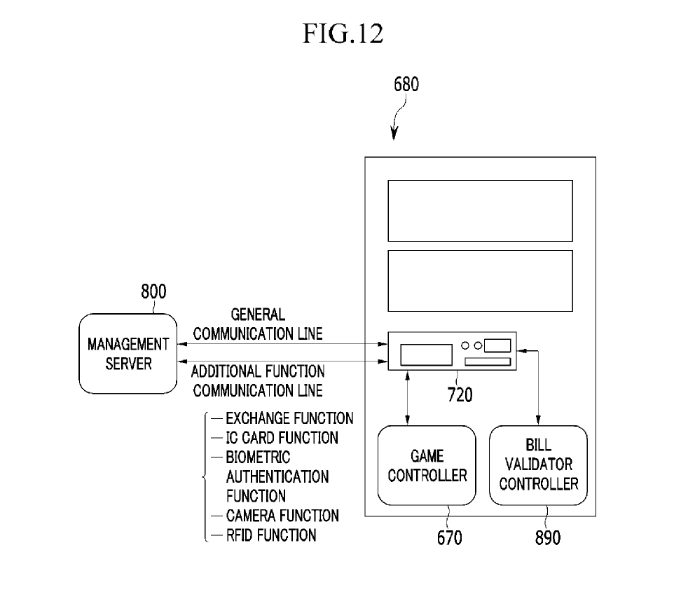

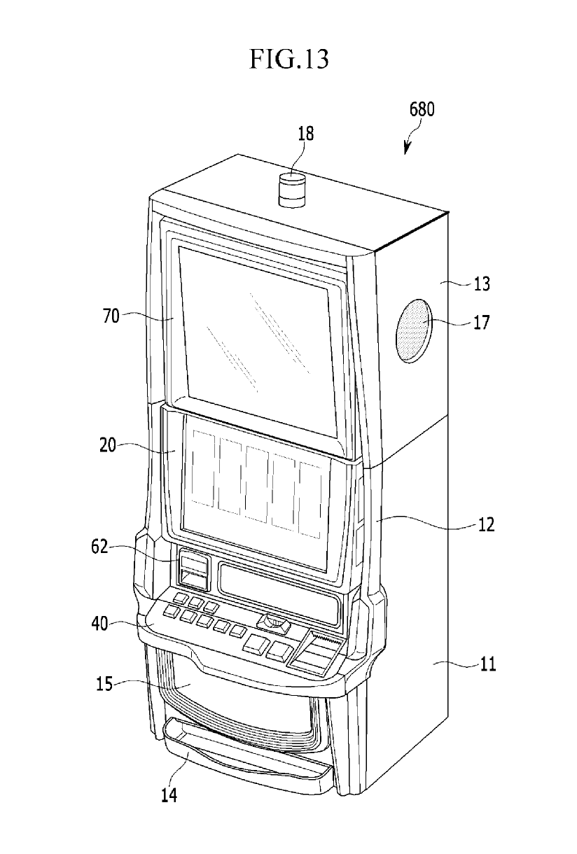

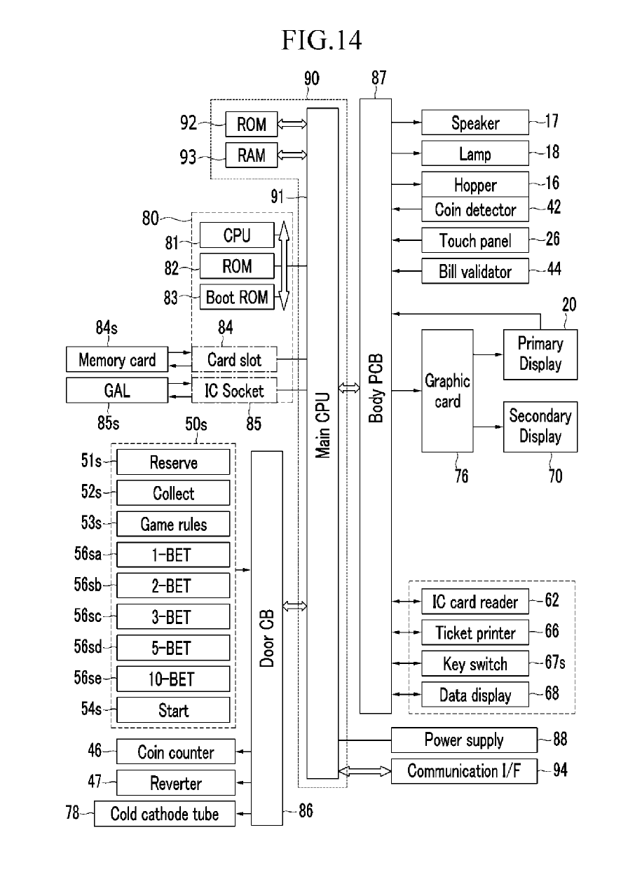

FIG. 8 is a schematic block diagram of an exemplary gaming machine showing a functional flow of the gaming machine according to an embodiment of the present invention, FIG. 9 is a schematic block diagram of an exemplary external controller showing a functional flow of the gaming machine shown in FIG. 8 according to an embodiment of the present invention, FIG. 10 is a schematic perspective view of the gaming machine shown in FIG. 8, FIG. 11 is a schematic block diagram of an exemplary gaming system according to an embodiment of the present invention, FIG. 12 is a schematic block diagram of an exemplary PTS system for a gaming machine according to an embodiment of the present invention, and FIG. 13 is a schematic perspective view of an exemplary slot machine in a gaming machine according to an embodiment of the present invention.

Functional Flow of Gaming Machine: Slot Machine

Referring to FIG. 8, a gaming machine 600 according to an embodiment of the present invention includes a plurality of slot machines 680 and an external controller (or a central controller) 690 connected to the plurality of slot machines 680 such that the external controller 690 may perform data communication with the plurality of slot machines 680.

Each of the slot machines 680 includes a display unit 614, a player tracker system (PTS) terminal 720, bet buttons 56, a spin button 54, a speaker 17, a lamp 18, and a game controller 670 controlling thereof. The slot machine 680 further includes a transceiver 652 for data communication with the external controller 690.

The bet buttons 56 and the spin button 54 are input elements that operate by pushing or pressing of a player. The bet buttons 56 are configured to accept a bet amount, and the spin button 54 is configured to accept start of a game.

The display unit 614 displays still images related to a plurality of symbols used in gaming, numbers, or signs and moving images such as a rendering image. The display unit 614 includes a primary display 20, a secondary display 70, and a common game display 614c. The primary display 20 displays symbols for a game, and the secondary display 70 displays a variety of images and information related to the game. The common game display 614c is adapted to display a common game such as a jackpot game, for example.

The game controller 670 includes a coin insertion/start check unit 603, a game execution unit 605, a condition determination unit 606, a symbol addition unit 607, a random number generator 615, a symbol determining unit 612, a rendering random number generator 616, a rendering effect determining unit 613, a winning prize determining unit 619, and a payout unit 620.

The game execution unit 605 may be configured to execute a game in a normal round or a free round. The condition determination unit 606 may determine whether a condition for executing a first-type free round or for a first-type free round of the game is satisfied. For example, when three or more feature symbols are shown in first to third symbol strips of a symbol arrangement in a normal round, the condition determination unit 606 may cause the symbol addition unit 607 to add wild symbols into the second symbol strip to a fifth symbol strip. When three or more feature symbols are shown in first to third symbol strips of a symbol arrangement in a first-type free round, the condition determination unit 606 may cause the symbol addition unit 607 to add top symbols to the first symbol strip.

The symbol determining unit 612 is configured: to determine a symbol arrangement using random numbers generated by the random number generator 615; to output the symbol arrangement to the primary display 20 of the display unit 614 to display the symbol arrangement thereon; to output information on the symbol arrangement to the winning prize determining unit 619; and to output information on the symbol arrangement to urge the rendering random number generator 616 to generate a random number for selecting a rendering mode based on the symbol arrangement.

The rendering random number generator 616 is configured: to generate a random number for rendering selection in response to the output from the symbol determining unit 612; and to output the generated random number to the rendering mode determining unit 613. The rendering mode determining unit 613 is configured: to determine the rendering mode with the use of the random number from the rendering random number generator 616; to output the determined rendering mode to the secondary display 70 of the display unit 614; and to output sound/lighting information of the determined rendering mode to the speaker 617 and the lamp 618.

The winning prize determining unit 619 is configured to determine the presence or absence of a winning prize based on the arrangement of the symbols displayed on the primary display 20; to calculate a payout amount based on the types of wins and betting amount; and to output a payout signal that informs of the payout amount to the payout unit 620. The payout unit 620 is configured to pay out the amount to a player in a form of a coin, a medal, a credit, or the like. In addition, the payout unit 620 is configured to add credit data based on a credit to be paid out to the credit that is stored in an IC card 500 inserted into a PTS terminal 720 to be described later.

Furthermore, the game controller 670 includes a storage 661 configured to store a variety of bet amount data. The storage 661 is a device configured to store data contained in a hard disk unit or a memory in a rewritable manner.

Moreover, the game controller 670 includes a common game execution unit 653. The common game executing unit 653 is configured to output bet amount information that is based on a bet amount betted in a game to the external controller 690 every time unit game is played; to execute a common game by means of a game start command from the external controller 690; and to accept a BET input by means of the bet buttons 56 as to a bet amount that corresponds to data on a bet amount data for common game that can be betted in a common game.

The game controller 670 is connected to the PTS terminal 720. The PTS terminal 720 may be configured to communicate with the game controller 670, for example, to send credit data, for example. The game controller 670 may update credits written on the display unit 614 when the credit controller receives the credit data from the PTS terminal 720. The game controller 670 may output liquidation credit data to the PTS terminal 720 in a case where a game liquidation has occurred.

The PTS terminal 720 is connected to a management server 800 to enable communication therewith, and integrally performs image downloading or management of IC card or credit.

Functional Flow of Gaming Machine: External Control Device

Referring to FIG. 9, the slot machines 680 are connected to an external controller 690. The external controller 690 has a function of remotely operating and remotely monitoring an operating state of each slot machine 680 or a processing operation such as changing a variety of game setting values. Furthermore, the external controller 690 has a function of determining a common game start condition for each game terminal and then executing a common game in a plurality of slot machines 680 when a determination result satisfying the common game start condition has been obtained in any of the game terminals.

The external controller 690 includes a common game start unit 694, a game terminal selecting unit 692, and a transceiver 696 (not shown).

The common game start unit 694 is configured: to determine whether or not a common game start condition is established, based on a cumulative value of bet amount information that is transmitted from a slot machine 680 in each game round; to output a game start command to a plurality of slot machine 680; and to display a state that is established until the common game start condition has been established on the common display device 700.

Determination of whether or not the common game start condition is established may be made based on all of the cumulative values that are obtained by repetition of a unit game as well as based on a cumulative value of bet amount information. For example, the number of games or a game playing time and the like may be a cumulative value.

Furthermore, the common game start unit 694 is configured to output a game start command to a slot machine 680 in which a cumulative value increasing due to repetition of a game satisfies a game execution condition. In this manner, the common game start unit 694 enables a player to have a consciousness to actively repeat a game because a qualification to participate in a common game is not provided to a slot machine 680 whose cumulative value is less than a minimum setting value.

Furthermore, the common game start unit 694 is configured to monitor a non-input time during which no start operation is made and then outputting a game start command to the slot machines 680 other than a slot machine 680 whose non-input time is more than a timeout time. In this manner, the common game start unit 694 is capable of determining that a player is absent as to a slot machine 680 in which no game is executed over a timeout time or more, and is capable of avoiding execution of a common game for such a slot machine 680.

The game terminal selecting unit 692 has a function of selecting a specific slot machine 680 from among a plurality of slot machines 680 and then outputting a common game start command signal to the specific slot machine 680. The transceiver 696 has a function enabling transmission/reception of data to/from the slot machine 680.

Entire Configuration of Game System

A game system that includes gaming machines 600 having the respective functions described above is described.

Referring to FIG. 10, a gaming machine 600 includes a plurality of slot machines 680 and an external controller 690 that is connected to each of the slot machines 680 via a communication line 665.

The external controller 690 is configured to control a plurality of slot machines 680. In the embodiment of the present invention, the external controller 690 is a so called hall server that is installed in a gaming facility having a plurality of slot machines 680. Each of the slot machines 680 has its own identification number assigned thereto, and the external controller 690 determines a source of data to be transmitted from each of the slot machines 680, in accordance with the assigned identification number. In addition, in a case where data is transmitted from the external controller 690 to a slot machine 680 as well, a transmission destination is specified with the use of the assigned identification number.

A game system may be configured in one gaming facility that is capable of performing a variety of games, such as a casino, or may be constructed across a plurality of gaming facilities. In a case where the game system is constructed in one gaming facility, the game system may be constructed every floor or every section in the gaming facility. The communication line 665 may be wired or wireless, and a leased line or a switched line and the like can be employed.

Referring to FIG. 11, a game system is divided into three blocks, i.e. a management server block 800, a customer terminal block 700, and a staff terminal block 900. The management server block 800 includes a casino hall server 850, a money exchange server 860, a casino/hotel staff management server 870, and a download server 880.

The casino hall sever 850 is a server configured to manage an entire casino hall in which slot machines 680 have been installed. The money exchange server 860 is a server configured to prepare money exchange rate data based on money exchange information. The casino/hotel staff management server 870 is a server configured to manage staffs in a casino hall or a hotel associated with the casino hall. The download server 880 is a server configured to download information relating to games or the latest information such as news and then broadcast the downloaded information to players through the PTS terminals 700 of a variety of slot machines 680.

In addition, the management server block 800 has a member management server 810, an IC card & money management server 820, a megabucks server 830, and an image server 840.

The member management server 810 is a server configured to manage members information on a player who plays a game at a slot machine 680. The IC card & money management server 820 is a server configured to manage an IC card 500 used in a slot machine 680. Specifically, the IC card & money management server 820 is a server configured to store fraction money data to be associated with an identification code or to output the fraction money data to the PTS terminal 720. The IC card & money management server 820 is also configured to prepare and manage denomination data or the like. The megabucks server 830 is a server configured to manage megabucks serving as games in which a total amount of betted money in a plurality of slot machines 680 installed in a plurality of casino hall is determined as a prize. The image server 840 is a server configured to download an image relating to a game or a latest image such as news, for example, and then, broadcast the downloaded image to players through the PTS terminal 720 of a variety of slot machines 680.

The customer terminal block 700 has a slot machine 680, a PTS terminal 720, and a liquidation machine 750. The PTS terminal 700 can be mounted on the slot machine 680 and can communicate with the management server 800. The liquidation machine 750 is a machine configured to cash out and liquidate money data that is stored in an IC card 500 that a player owns or to store a coin or a bill as money data in the IC card 500.

The staff terminal block 900 has a staff management terminal 900 and a member card issuing terminal 950. The staff management terminal 900 is a terminal for staffs in a casino hall to manage a variety of slot machines 680. In particular, in the case of the embodiment of the present invention, the staffs in a casino hall manage whether too many IC cards 500 are stocked in the PTS terminal 720 or the number of IC cards 500 is insufficient. The member card issuing terminal 950 is a terminal for a player who plays a game in a casino hall to use when issuing a member card.

PTS Terminal

Referring to FIG. 12, a PTS terminal 720 is incorporated in a PTS system. The PTS terminal 720 that is mounted on a slot machine 680 is connected to a game controller 670 and a bill validator controller 890 of the slot machine 680 to enable communication therewith.

The PTS terminal 720 performs rendering of a game by means of sound or image and the like or updating of credit data in communication with the game controller 670. In addition, the PTS terminal 720 transmits credit data required for liquidation in communication with the bill validator controller 890.

In addition, the PTS terminal 720 is connected to a management server 800 to enable communication therewith. The PTS terminal 720 communicates with the management server 800 between two lines, i.e., between a general communication line and an additional function communication line.

The PTS terminal 720 makes communication of data such as money data or identification code data or members information on players, for example, in the general communication line. On the other hand, the PTS terminal 720 makes communication relating to functions to be newly added in the additional function communication line. In the case of the embodiment of the present invention, the PTS terminal 720 makes communication relating to an exchange function, an IC card function, a biological authentication function, a camera function, or an RFID (Radio Frequency IDentification) function serving as a function of making solid identification with the use of radio waves.

Mechanical Configuration of Slot Machine

An exemplary structure of the slot machine 680 that includes elements other than those above listed is shown in FIG. 13, but the structure of the slot machine 680 is not limited thereto.

Referring to FIG. 13, the slot machine 680 includes a cabinet 11, a top box 12, a main door 13, a primary display 20, a secondary display 70, a control panel 40, a speaker 17, and a lamp 18.

The primary display 20 displays a symbol arrangement selected from a set of symbols SB including picture symbols SB1, character symbols SB2, and functional symbols SB3 as shown in FIG. 1. The symbols SB1 are denoted by pictures of a moose, a bear, a wolf, a beaver, and a woodpecker, and character symbols SB2 are denoted by “9,” “10,” “J,” “Q,” “K,” and “A.” The functional symbols SB3 include a feature symbol SB31 denoted by “FEATURE” and a wild symbol SB32 denoted by “WILD.” The feature symbol SB32 may serve as a scatter symbol, and the moose symbol S11 may serve as a top symbol.

The primary display 20 may be disposed on an upper part of the main door 13 that may be provided on a front surface of the cabinet 11, and may include an LCD panel or an OLED panel. The primary display 20 may include a touch screen panel that enables a player to interact with the slot machine 680 by touching some areas on a screen.

The secondary display 70 displays images related to game information or images. The secondary display 70 may be disposed on a front surface of the top box that may be provided on the cabinet 11, and may include a display panel, for example, a liquid crystal display (LCD) panel or an organic light emitting display (OLED).

Referring to FIG. 13, the control panel 40 includes a plurality of buttons, a coin entry, and a bill entry, and may be disposed below the primary display 20.

The plurality of buttons may include a reserve button, a take win button (or collect button), and a game-rules button (or help button) that may be disposed on an upper stage of a left area of the control panel 40. The plurality of buttons may further include a plurality of m-bet buttons (m=1, 2, 3, 5, 10) (or bet×n buttons) that may be disposed at a lower stage of in a left area. The plurality of buttons may further include and a max bet button and a start button (or repeat button) that may be disposed right to the m-bet buttons. The coin entry and the bill entry may be disposed upper to the max bet button and the start button.

The reserve button may be an operating button to be used when a player wants to leave a seat or when a player wants to request the staffs in a gaming facility to exchange money. The take win button may be a cash-out button used to add the credit data relating to credits obtained in a variety of games to the credit data that is stored in the smart card or output the bill or the ticket corresponding to the total credits. The help button may be a button to be used when a user does not clearly understand how to play a game or the like, and when the help button is pressed, a variety of help information including game rules may be displayed on the primary display 20.

The 1-bet button may be used when player's current credits are betted on a one-by-one basis for each winning payline every time the button is pressed. In this embodiment, an amount of 1 BET may correspond to 50 credits such that all the paylines are selected. The m-bet button (m>1) may be a button for starting a game in m BETs for each winning payline. Therefore, a bet amount to for winning paylines may be determined by pressing any one of the m-bet button. If the player bets N BETs by pressing the N-bet button, default credits (for example 50 credits) of the winning paylines may be multiplied by N such that the multiplied credits are awarded to the player. Furthermore, the player can bet (N+M) BETs by pressing the N-bet button and the M-bet button in sequence. At this time, the slot machine 680 may restrict an upper limit of the bet amount.

The max bet button may be an operating button to be used when a maximum amount are betted.

The spin button may be an operating button to be used when scrolling symbols in a game and when starting a rotation of a selection wheel in a bonus game.

The coin entry may be configured to accept the coin in the cabinet 11. The bill entry may be configured to validate whether the entered bill is legitimate or not and to accept a legitimate bill in the cabinet 11. Moreover, the bill entry may accept the ticket having the barcode.

The slot machine 680 may further include an integrated circuit (IC) card reader 62 disposed below the primary display 20. The IC card reader 62 receives an IC card which stores information of player identification and game log related with the games previously played by the player, for example. In addition, the IC card may store data equivalent to coins, bills, or credits owned by the player. The IC card reader 62 reads and writes data from and to the inserted IC card. The IC card reader 62 may include an LCD for displaying the data read from the IC card.

The slot machine 680 further include a speaker 17 for outputting sound effects and a lamp 18 for light flashing.

Electronic Configuration of Slot Machine

Next, a configuration of a circuit included in a slot machine 680 will be described with reference to FIG. 14.

FIG. 14 is an electrical block diagram of the slot machine according to an embodiment of the present invention.

Referring to FIG. 14, the slot machine 180 includes a gaming board 80, a motherboard 90, and a door PCB 86, and a body PCB 87.

A gaming board 80 includes a CPU 81, a ROM 82 accessible by the CPU 81 through an internal bus, and a boot ROM 83 accessible by the CPU 81 by an internal bus. The gaming board 80 additionally includes a card slot 84 which can receive and communicate with a memory card 84s, and an IC socket 85 provided correspondingly to a Generic Array Logic (GAL) 85s.

The memory card 84s may include a non-volatile memory and may store a game program and a game system program.

The card slot 84 is configured to receive and eject the memory card 84s, and is connected to a motherboard 90 by an IDE bus. The details of the game performed in the slot machine 1 may be changed by replacing the memory card 84s with another one, or by withdrawing the memory card 84s from card slot 84, writing another program into the memory card 84s, and then inserting the memory card 84s into the card slot 84 again.

The GAL 85s, which is a type of a Programmable Logic Device (PLD) having a fixed OR array structure, has a plurality of input ports and output ports. When the GAL 85s receives certain data through the input ports, it outputs data corresponding to the input data through the output ports.

The IC socket 85 is configured in such a manner that the GAL 85s can be inserted into the IC socket 85 or detached from the IC socket 85, and connected to a motherboard 90 by a PCI bus.

The CPU 81, the ROM 82, and the boot ROM 83 interconnected by the internal bus are connected to the motherboard 90 by the PCI bus. The PCI bus enables signal transmission between the motherboard 90 and the gaming board 80, and supply of power from the motherboard 90 to the gaming board 80.

The ROM 82 stores an authentication program. The boot ROM 83 stores a preliminary authentication program, a boot code to be used by the CPU 81 for activating the preliminary authentication program, and the like. The authentication program is a tamper check program for authenticating the originality of the game program and the game system program. The preliminary authentication program is a program for authenticating the originality of the authentication program. The authentication program and the preliminary authentication program are written in a sequence of proving that the subject program has not been tampered.

The motherboard 90, which may be implemented using a commonly available general main board, executes the game program and the game system program. The motherboard 90 includes a main CPU 91, a ROM 92, a RAM 93, and a communication interface 94.

The ROM 92, which may be a flash memory, may be configured to store a program to be executed by the main CPU 91 such as BIOS, along with another data to be maintained permanently. When being executed by the main CPU 91, the BIOS performs initialization of peripheral devices. Also, the BIOS starts to load the game program and the game system program stored in the memory card 54 through the gaming board 80. The ROM 92 may be rewritable. However, write-protected one might be used as the ROM 92 as well.

The RAM 93 stores data and programs which are used during the operation of the main CPU 91. For example, when the game program, the game system program, or the authentication program is to be loaded, the RAM 93 can store such programs. Also, the RAM 93 is provided with working space for the execution of the programs. Examples of the space include a space for storing the number of bets, the payout amount, the credit amount, and the like can be maintained during the execution of the game. Also, plurality of tables defining symbols, symbol codes, winning combinations, and their probabilities are maintained during the execution of the game. Further, the RAM 93 stores symbol code determination tables which stores mapping information between symbol codes and random number which can used for determining symbols based on random numbers. In particular, the RAM 93 maintains a mode flag indicating the gaming mode, along with a game and a game counter of which count value indicates the number of executed chance mode games or the number of possibly remaining chance mode games.

Also, the RAM 93 stores count values of a plurality of counters, which include a bet counter, a payout amount counter, a credit amount counter, and a chance mode game counter which counts the number of chance mode games. Alternatively, however, some of the count values can be maintained in an internal register of the main CPU 91.

The communication interface 94 facilitates data communication of the main CPU 91 with an external controller of, for example, a server through a communication channel.

Besides, the motherboard 90 is connected to the door PCB 86 and the body PCB 87 by USB communications. The motherboard 90 is also connected to a power supply 88. The main CPU 91 of the motherboard 90 boots up and operates using the power supplied from the power supply 88, and passes over some of the power to the gaming board 80 through the PCI bus so as to boot up the CPU 81. The door PCB 86 and the body PCB 87 are connected to input devices such as a switch and a sensor, and peripheral devices of which operation are controlled by the main CPU 91. Also, the door PCB 86 is connected with a control panel 40, a coin counter 46, a reverter 47, and a cold cathode tube 78.

The control panel 40 has a reserve switch 51s, a collect switch 52s, a game rule switch 53s, a start switch 54s, a 1-BET switch 56as, a 2-BET switch 56bs, a 3-BET switch 56cs, a 5-BET switch 56ds, and a 10-BET switch 56es, each of which is provided correspondingly to respective buttons 51 to 54 and 56a to 56e. The switches 51s to 54s and 56as to 56es detects pressing of the respective buttons to output signals to the main CPU 91.

The coin counter 46 and the reverter 47 are disposed in the coin entry. The coin counter 46 validates legitimacy of coins inserted into the coin entry in terms of material, shape, or the like. The coin counter 46 outputs a signal to the main CPU 91 when detecting a legitimate coin. Meanwhile, illegitimate coins are discharged to the coin tray 15. The reverter 47, which operates based upon a control signal from the main CPU 91, distributes the legitimate coins validated by the coin counter 46 into either a hopper 16 or a cash box (not shown in the drawing). The coins are guided into the hopper 16 when the hopper 16 is not filled with coins. Contrarily, however, the coins are guided into the cash box when the hopper 16 is filled with coins.

The cold cathode tube 78, which is disposed on the rear face of the secondary display 70, functions as a backlight and illuminates based on a control signal from the main CPU 91.

The body PCB 87 is connected with the speaker 17, the lamp 18, the hopper 16, a coin detector 42, the touch panel 26, a bill validator 44, the reel assembly 30, the IC card reader 62, a graphic card 76, the ticket printer 66, a key switch 67s, and the data display 68.

The lamp 18 flashes based upon a control signal from the main CPU 91. The speaker 17 outputs a sound such as BGM based upon the control signal from the main CPU 91.

The hopper 16, which operates based upon a control signal from the main CPU 91, pays out coins of the designated payout amount to the coin tray 15 through a coin payout exit formed between the belly glass 14 and the coin tray 15. The coin detector 42 detects coins paid out from the hopper 16 to output a detection signal to the main CPU 91.

The touch panel 26 detects a position touched by the player to provide the main CPU 91 with a position sense signal corresponding to the detected position. The bill validator 44 in the bill entry provides, upon detection of a legitimate bill, the main CPU 91 with a bill detection signal corresponding to the bill amount.

The graphic card 76 controls a primary display 20 and a secondary display 70 in response to a control signal from the main CPU 91. The graphic card 76 may include a Video Display Processor (VDP) generating video data, and a video RAM temporarily storing the video data. The video data may be originated from the game program stored in the RAM 93.

The IC card reader 62 reads out data stored in the IC card inserted into the card slot 176 to provide the read-out data to the main CPU 91. Also, the IC card reader 62 writes data received the main CPU 91 into the ID card.

The ticket printer 66 prints on a ticket the barcode containing information of the credit amount stored in the RAM 93, date and time, the identification number of the slot machine 1, and the like, in response to the control signal from the main CPU 91 to output the barcode imprinted ticket.

The key switch 67s, which is disposed behind the keypad 67, outputs a key detection signal to the main CPU 91 when the keypad 67 is pressed by the player.

The data display 68 displays information related the input through the keypad 67 in response to a control signal from the main CPU 91.

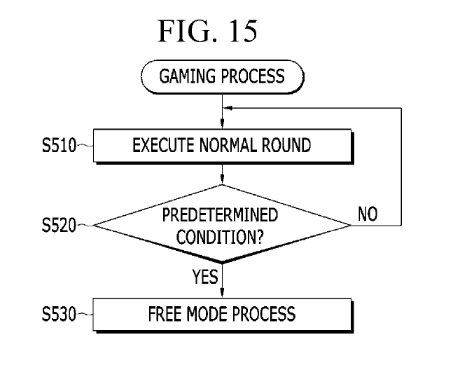

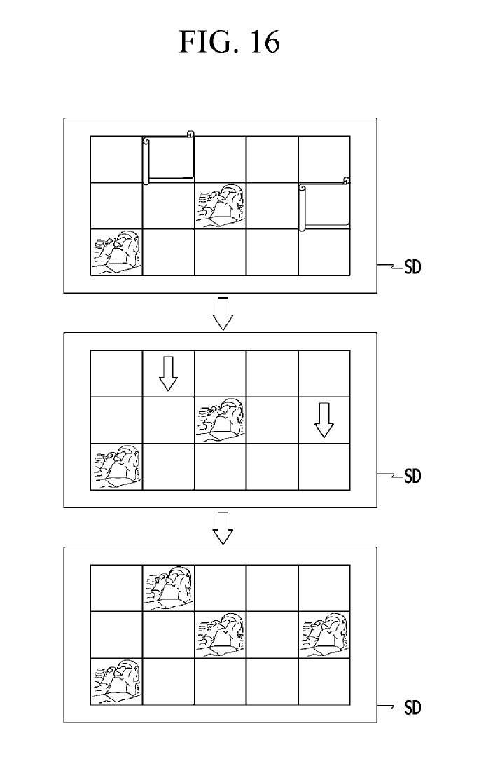

A gaming method according to another embodiment of the present invention is described in detail with reference to FIG. 15 and FIG. 16.

FIG. 15 is a schematic flow chart illustrating a gaming method according to an embodiment of the present invention, and FIG. 16 shows screen shots illustrating a gaming method according to an embodiment of the present invention.

A gaming method according to anther embodiment of the present invention, the gaming machine 1 may execute a game in a normal mode or a free mode. Although a player playing in the normal mode may be required to bet some coins or credits on each game round in the normal mode, the free mode may not require a player's betting.

A symbol set for a normal round of the game may be also used in a free round of the game. For example, the symbol code table shown in FIGS. 6A and 6B are used both for the normal round and the free round. However, different symbol sets may be used in the normal round and the free round.

Referring to FIG. 15, the controller CN executes a normal round of the game in response to inputs from a player (S510). The normal round may be performed as described with reference to FIG. 4 and FIG. 5 using a symbol set shown in FIGS. 6A and 6B and a symbol subset shown in FIG. 7.

Referring to FIG. 4 and FIG. 5, for example, the controller CN determines a symbol arrangement (S410) selected from a symbol set, and the symbol arrangement is displayed in the symbol display SD. Thereafter, the controller CN determines whether one or more map symbols MAP are included in the symbol arrangement (S420). When it is determined that the symbol arrangement includes one or more map symbols MAP, the controller CN determines a symbol that substitutes for each of the map symbols MAP in the symbol arrangement and replaces each map symbol MAP with the substitute symbol (S430). The substitute symbol may be selected from a subset of the symbol set. The symbol display SD shows scrolling of the symbol subset on each display block occupied by the map symbols MAP and stopping of the substitute symbol in a corresponding display block. When two or more map symbols MAP are included in the symbol arrangement, the scrolling of the symbol subset on the display blocks occupied by the map symbols MAP may be performed in a simultaneous manner, and thus the scrolls on the display blocks may start simultaneously and stop simultaneously. Subsequently, the controller CN performs win determination based on a finalized symbol arrangement including the substitute symbol (S440).

As well as win determination, the controller CN determines whether a predetermined condition for triggering a free mode process is satisfied (S520). According to an embodiment of the present invention, the controller CN may determine, as the predetermined condition, whether the finalized symbol arrangement includes either a predetermined number of first wild symbols WILD_1 or a predetermined number of second wild symbols WILD_2. According to another embodiment, the controller CN may determine, as the predetermined condition, whether each of first to fourth columns (or symbol strips) in the finalized symbol arrangement includes a first wild symbol WILD_1 or a second wild symbol WILD_2. According to an embodiment of the present invention, the first wild symbol WILD_1 and the second wild symbol WILD_2 may be treated as different symbols when determining the satisfaction of the predetermined condition.

FIG. 16 shows an example of a finalized symbol arrangement that satisfies the predetermined condition, which is obtained by a map symbol replacement.

Referring to FIG. 16, a symbol arrangement including two first wild symbols WILD_1 in first and third columns (or symbol strips) and two map symbols MAP in second and fourth columns is determined and shown on the symbol display SD. The display blocks of the symbol display SD, which are occupied by the two map symbols MAP, show scrolling of the symbols in the symbol subset in a simultaneous manner, and finally, other two first wild symbols WILD_1 stop in the display blocks such that the finalized symbol arrangement satisfied the predetermined condition.

Referring to FIG. 15 again, when the predetermined condition is not satisfied (S520: NO), the controller CN executes another normal round of the game (S510).

However, when the predetermined condition is satisfied (S520: YES), for example, when the first to fourth columns in the symbol arrangement include respective first or second wild symbols WILD_1 or WILD_2 as shown in FIG. 16, the controller CN triggers a free mode process (S530).

The free rounds of the game may be executed in a manner similar to the normal rounds of the game.

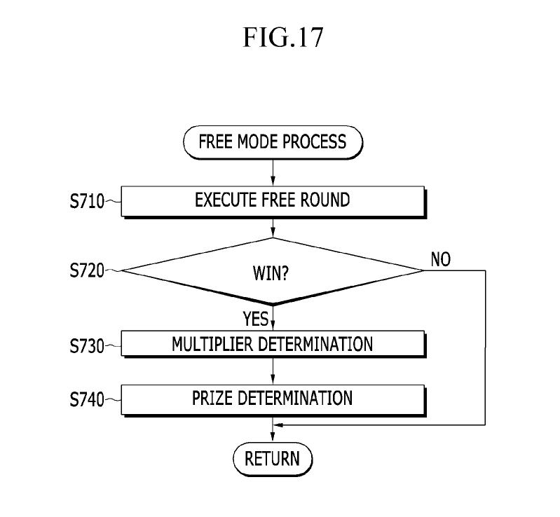

According to an embodiment of the present invention, a prize for a win in the free rounds may be greater than a prize for the win in the normal rounds. For example, the win prize in the free rounds may be obtained by multiplying the win prize in the normal rounds by a multiplier determined at random, an example of which is described in detail with reference FIG. 17 to FIG. 19.

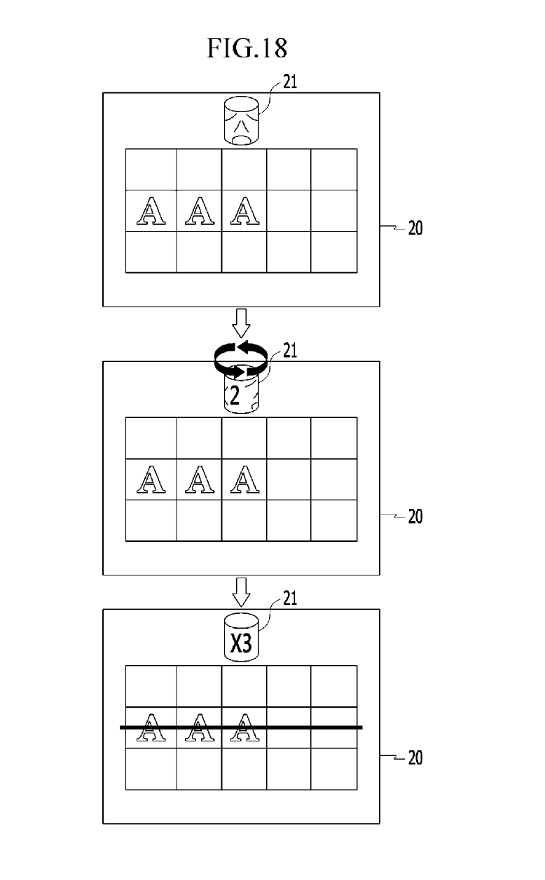

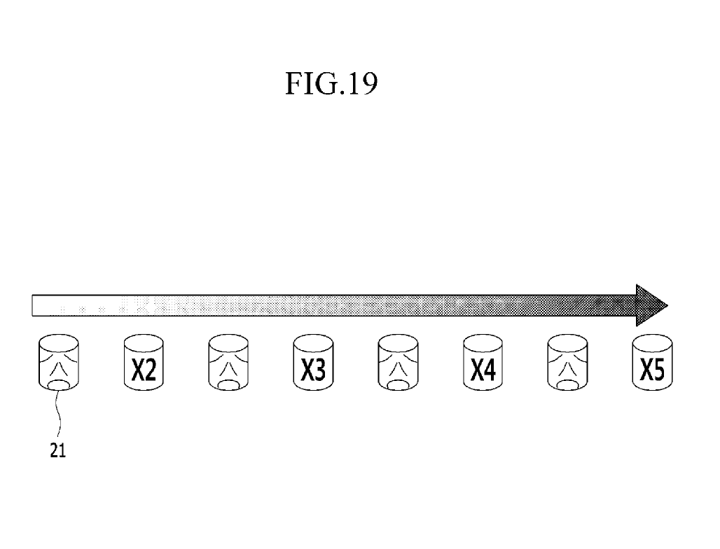

FIG. 17 is a schematic flow chart showing a free mode process of a game according to an embodiment of the present invention, FIG. 18 are exemplary screen images illustrating a gaming method according to an embodiment of the present invention, and FIG. 19 shows rotation of a moai character in a gaming method according to an embodiment of the present invention.

Referring to FIG. 17, a free round of a game that may be triggered by a predetermined condition in a normal round is executed in a manner similar to a normal round of the game (S710). For example, determination of a symbol arrangement and replacement of a map symbol are performed to obtain a finalized symbol arrangement.

It is determined whether the finalized symbol arrangement includes a win (S720). If a win occurs in the finalized symbol arrangement (S720: YES), a multiplier for a prize of the win is determined at random (S730), for example, using a random number generator (not shown).

The determination of the multiplier may be displayed on the symbol display SD as shown in FIG. 18.

Referring to FIG. 18, a moai character 21 appears at an upper central part of the symbol display SD when a win occurs. The moai character 21 rotates to show candidate multipliers. FIG. 19 shows exemplary multipliers including twice denoted by X2, three times denoted by X3, four times denoted by X4, and five times denoted by X5, but the candidate multipliers are not limited thereto. The candidate multipliers may be shown in sequence on a back of the moai character 21, and thus a face of the moai character 21 and the candidate multipliers are shown alternately during the rotation of the moai character 21. Thereafter, the moai character 21 stops its rotation and shows its back on which the determined multiplier is written.

Referring to FIG. 17 again, a final prize for the win is calculated by multiplying a normal prize for the win by the determined multiplier (S740). When two or more wins occur, a normal prize for each of the wins may be multiplied by the determined multiplier to form a final prize.

Embodiments of the present invention can also be embodied as a computer readable program on a computer-readable recording medium. The computer readable recording medium is any data storage device that can store data that can be read thereafter by a computer. Examples of the computer readable recording medium include ROMs, RAMs, CD-ROMs, magnetic tapes, floppy disks, and optical data storage devices. The computer readable recording medium can also be distributed over a network coupled computer system so that the computer readable code is stored and executed in a distributed fashion.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A gaming machine comprising:
a display device that includes a plurality of display blocks arranged in rows and columns;
a memory that stores a first reel data including a plurality of first symbols and a first plurality of win-related symbols and a second reel data including a second plurality of win-related symbols, the first reel data configured to be scrolled entirely in the columns of the display blocks and the second reel data configured to be scrolled locally in one or more of the display blocks;
a controller configured to award a prize for a symbol arrangement including the win-related symbols,
wherein from begging of a game round to completion of arranging the win-related symbols, the controller configured
to scroll first reel images including the plurality of first symbols and the first plurality of win-related symbols in each of the columns of the display device based on the first reel data,
to stop the first reel images at random entirely in each of the columns of the display device,
to scroll second reel images including the second plurality of win-related symbols locally in a first display block of the display blocks based on the second reel data when it is determined that a first one of the plurality of first symbols stops in the first display block,
to stop the second reel images at random in the first display block, and
to award a prize based on a finalized symbol arrangement obtained after stopping the second reel images.

2. The gaming machine of claim 1, wherein the memory further stores a prize table that determines prizes for wins formed by at least one of the win-related symbols.

3. The gaming machine of claim 1, wherein the controller is configured to scroll the second reel images locally in a second display block of the display blocks based on the second reel data when it is determined that a second one of the plurality of first symbols stops in the second display block, and
the scroll in the first display block and the scroll in the second display block start simultaneously and stop simultaneously.

4. The gaming machine of claim 3, wherein an arrangement of the second plurality of the win-related symbols in the second reel data for the scroll in the second display block is different from an arrangement of the second plurality of the win-related symbols in the second reel data for the scroll in the first display block.

5. The gaming machine of claim 3, wherein an arrangement of the second plurality of the win-related symbols in the second reel data for the scroll in the second display block is substantially the same as an arrangement of the second plurality of the win-related symbols in the second reel data for the scroll in the first display block, and
any two of the second plurality of the win-related symbols in the second reel data are different from each other.

6. The gaming machine of claim 1, wherein the second plurality of the win-related symbols in the second reel data include a wild symbol that is configured to substitute for any other symbol.

7. The gaming machine of claim 6, wherein a proportion of the number of the wild symbol in the second reel data is greater than a proportion of the number of the wild symbol in the first reel data.

8. The gaming machine of claim 1, wherein the controller is further configured
to determine whether the finalized symbol arrangement includes a win,
to determine a multiplier when the finalized symbol arrangement includes a win, and
to calculate a final prize based the win and the determined multiplier.

9. The gaming machine of claim 8, wherein the controller is further configured to display a character on the display device, the character rotating for a predetermined time to show a plurality of candidate multipliers and stopping to show the determined multiplier.

10. A gaming method comprising:
scrolling a set of symbols on a display device, the set of symbols including first symbols and other symbols;
stopping a symbol arrangement including symbols selected from the set of symbols on the display device, each symbol in the symbol arrangement occupying a display block of the display device;
determining whether the symbol arrangement includes at least two of the first symbols;
scrolling a first subset of symbols selected from the set of symbols on a first display block occupied by a first one of the at least two of the first symbols when the symbol arrangement includes the at least two of the first symbols;
scrolling a second subset of symbols selected from the set of symbols on a second display block occupied by a second one of the at least two of the first symbols when the symbol arrangement includes the at least two of the first symbols;
stopping a second symbol and a third symbol in the first display block and the second display block, respectively, the second symbol selected from the first subset of symbols and the third symbol selected from the second subset of symbols, thereby forming a finalized symbol arrangement; and
determining payout based on the finalized symbol arrangement,
wherein the scrolling the first subset of symbols on the first display block and the scrolling the second subset of symbols on the second display block are performed in a simultaneous manner.

11. The gaming method of claim 10, wherein the scrolling of the first subset of symbols on the first display block and the scrolling of the second subset of symbols on the second display block start simultaneously and stop simultaneously.

12. The gaming method of claim 10, wherein the first subset of symbols is substantially the same as the second subset of symbols.

13. The gaming method of claim 12, wherein each of the first and second subsets of symbols includes a wild symbol that is configured to substitute for other symbols.

14. The gaming method of claim 13, wherein a proportion of the number of the wild symbol in each of the first and second subsets of symbols is greater than a proportion of the number of the wild symbol in the set of symbols.

15. The gaming method of claim 10, wherein the determining payout comprises:
determining whether the finalized symbol arrangement includes a win;
determining a multiplier when the finalized symbol arrangement includes a win; and
calculating a final prize based the win and the determined multiplier.

16. The gaming method of claim 15, wherein the determining payout further comprises:
displaying a character on the display device, the character rotating for a predetermined time to show a plurality of candidate multipliers and stopping to show the determined multiplier.

17. A gaming method comprising:
scrolling a set of symbols on a display device, the set of symbols including first symbols and other symbols;
determining a symbol arrangement including symbols selected from the set of symbols;
stopping the symbol arrangement on the display device, each symbol in the symbol arrangement occupying a display block of the display device;
determining whether the symbol arrangement includes at least two of the first symbols;
scrolling a first subset of symbols selected from the set of symbols on a first display block occupied by a first one of the at least two of the first symbols when the symbol arrangement includes the at least two of the first symbols;
scrolling a second subset of symbols selected from the set of symbols on a second display block occupied by a second one of the at least two of the first symbols when the symbol arrangement includes the at least two of the first symbols;
determining a second symbol from the first subset of symbols to substitute for the first one of the at least two of the first symbols;
determining a third symbol from the second subset of symbols to substitute for the second one of the at least two of the first symbols;
stopping the second symbol and the third symbol in the first display block and the second display block, respectively, thereby forming a finalized symbol arrangement; and
determining payout based on the finalized symbol arrangement,
wherein the scrolling the first subset of symbols on the first display block and the scrolling the second subset of symbols on the second display block are performed in a simultaneous manner.

18. The gaming method of claim 17, wherein the scrolling of the first subset of symbols on the first display block and the scrolling of the second subset of symbols on the second display block start simultaneously and stop simultaneously.

19. The gaming method of claim 17, wherein the first subset of symbols is substantially the same as the second subset of symbols.

20. The gaming method of claim 19, wherein the second symbol is the same as the third symbol.
